(19) United States
(12) Patent Application Publication
(10) Pub. No.: US 2016/0141097 A1
(43) Pub. Date: May 19, 2016

(54) MULTI-PLANE RECEIVING COIL FOR WIRELESSLY CHARGING A BATTERY

(71) Applicant: MOTOROLA SOLUTIONS, INC, SCHAUMBURG, IL (US)

(72) Inventors: WEI LUN OO, PENANG (MY); CHEE KHON CHONG, GEORGETOWN (MY); SIN KENG LEE, BAYAN LEPAS (MY)

(21) Appl. No.: 14/541,436

(22) Filed: Nov. 14, 2014

(51) Int. Cl. H01F 38/14; H01F 27/28; H01F 41/04; H02J 7/02; H02J 7/00

(52) U.S. Cl. CPC H01F 38/14; H02J 7/025; H02J 7/0042; H02J 7/007; H01F 41/046; H01F 27/2804

(57) ABSTRACT

A multi-plane receiving coil structure includes a receiving coil having at least a first planar section and a second planar section where the windings of the receiving coil each traverse both planar sections. The planar sections include at least two planar sections that are not parallel, and which can be “L,” “J,” or “U” shaped. The receiving coil structure is disposed in a device that includes, or is coupled to, a battery to be charged by receiving energy from a charging coil of a wireless charger via the receiving coil structure.

### FIELD OF THE DISCLOSURE

The present disclosure relates generally to wireless power transfer, and more particularly to wireless charging of a rechargeable battery used for powering a portable device.

### BACKGROUND

Wireless charging allows a battery coupled to a portable device to be charged without the use of conventional electrical connectors, which allows a user a more flexible means for recharging a battery. A similar technology uses inductive charging where a primary coil is located in a charging station, typically in a spindle, and a secondary coil is located in the device in which the battery to be charged is located. Inductive charging is considered to be “close coupled” because of the necessity to align the device with the charger, without any freedom to move the device from the charging position or place the device in a different position relative to the charging station.

Wireless charging, which employs magnetic resonance, however, is “loosely coupled” because there is only a general area in which to place a device, rather than a specific position relative to a wireless charger. This allows additional devices to be charged simultaneously by the wireless charger, without particular regard for the positioning of any of the devices so long as they are located within a charging area of the wireless charger. A typical wireless charger includes a charging coil that is wound in a generally planar orientation in a charging surface of the wireless charger. Devices to be used with a wireless charger, or battery packs used to power devices, contain a receiving coil that is also typically planar wound. The charging coil is excited with a charging power signal, which produces a charging field in the vicinity of the charging coil. The charging field is a time varying magnetic field that is coupled to the receiving coil, which is used to produce a direct current (DC) charging current and/or voltage.

However, given that both the charging coil and the receiving coil are typically planar or substantially planar wound coils, the most efficient charging occurs when the planes of the charging and receiving coils are substantially aligned within the charging area. Deviation from being parallel aligned reduces the efficiency of energy transfer from the charging coil to the receiving coil. In some cases when the charging coil and a receiving coil are oriented normal (orthogonal) to each other (i.e. their respective planes are at 90 degrees) the amount of energy transfer can drop to zero. Users of such devices may not have knowledge of the location and orientation of a receiving coil with respect to a given device in which the receiving coil is disposed (or in the battery pack powering the device). This can lead to users placing the device in the charging area of a wireless charger in an orientation that is sub-optimal for charging efficiency, or even resulting in no charging occurring.

Accordingly, there is a need for an arrangement that is orientation-independent to assure efficient charging in a wireless charger for different orientations of a device in a charging area of a wireless charger.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of charging circuit for use in wirelessly recharging a battery used to power a portable device, in accordance with some embodiments;

FIG. 2 is an isometric view of a multi-plane receiving coil for use in a device to wirelessly recharge a battery, in accordance with some embodiments;

FIG. 3 is a side view of an “L” shaped receiving coil structure for receiving power wirelessly from a charging coil of a wireless charger, in accordance with some embodiments;

FIG. 4 is an exploded isometric view of an “L” shaped receiving coil structure for receiving power wirelessly from a charging coil of a wireless charger, in accordance with some embodiments;

FIG. 5 is an isometric view of a multi-plane planar receiving coil structure having more than two planes, in accordance with some embodiments;

FIG. 6 is a side view of a device using a multi-plane receiving coil structure with the device laying on a side on top of a charging surface of a wireless charger, in accordance with some embodiments;

FIG. 7 is a side view of a device using a multi-plane receiving coil structure with the device standing upright on top of a charging surface of a wireless charger, in accordance with some embodiments;

FIG. 8 is a flow chart diagram of a method of forming a multi-plane receiving coil structure, in accordance with some embodiments;

FIG. 9 is an isometric view of a multi-plane receiving coil having a “U” shape, in accordance with some embodiments; and

FIG. 10 is an isometric view of a multi-plane receiving coil having a “J” shape and including flaps, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Embodiments include a charging circuit for receiving a wireless charging signal including a receiving coil having a plurality of windings. The receiving coil is a multi-plane receiving coil having a first planar section and a second planar section that is contiguous with the first planar section and oriented at an angle with respect to the first planar section. Each winding of the plurality of windings has a first portion of the winding in the first planar section and a second portion of the winding in the second planar section. In some embodiments ferromagnetic material is layered with the planar coil, wherein a first section of the ferromagnetic material is layered with the first planar section of the receiving coil and a second section of the ferromagnetic material is layered with the second planar section of the receiving coil.

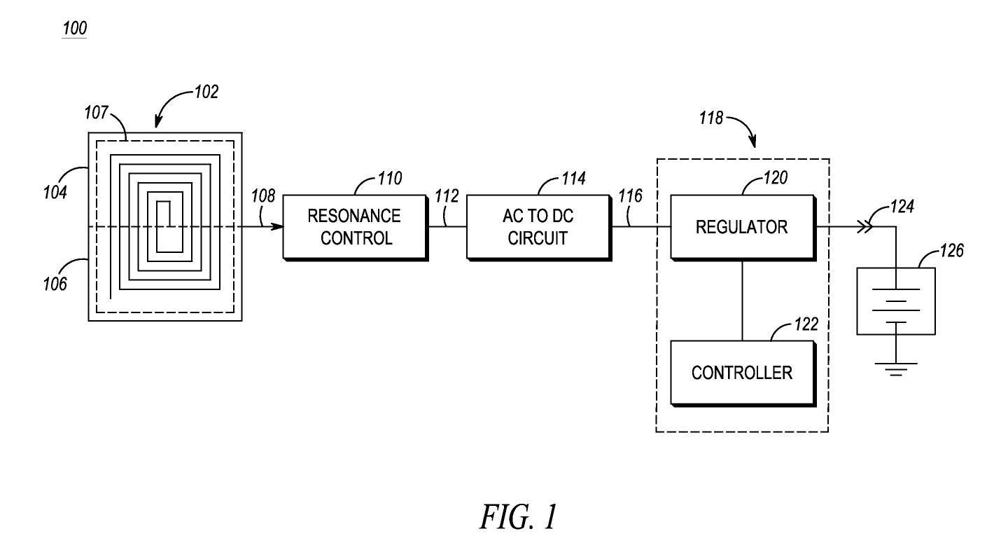

FIG. 1 is a block diagram of charging circuit 100 for use in wirelessly recharging a battery used to power a portable device, in accordance with some embodiments. The charging circuit 100 can be disposed in a portable device, or in another device such as a battery pack containing one or more rechargeable battery cells that are used to power a portable device. Wireless charging involves a wireless charger that generates a charging (magnetic) field, that is time varying, using an charging coil. The charging coil is typically a flat-wound coil that is positioned immediately under a dielectric surface on which portable electronic devices can be placed in order to recharge batteries used to power such devices. A receiving coil 102 is used to couple to the charging field and receive energy from the charging coil. The receiving coil 102 is also a flat-wound coil and can be a planar spiral-wound coil, where every winding is a successive loop in a spiral. Unlike a conventional planar receiving coil, however the receiving coil 102 is multi-planar, meaning it is arranged to have portions in more than one plane. Accordingly there is a first planar section 104 and a second planar section 106, which are contiguous (i.e. sharing a border). The first planar section 104 and the second planar section 106 each define planes that are oriented at an angle with respect to each other. For example, the receiving coil 102 can be folded along a midline anywhere along the receiving coil 102 such that the first planar section 104 and the second planar section 106 are oriented at ninety degrees with respect to each other. In some embodiments windings of the receiving coil have a portion of the winding on the first planar section 104 and a portion of the winding on the second planar section 106.

The charging field of a charging coil induces an alternating current (AC) signal 108 across the terminals of the receiving coil 102. A resonance control circuit 110 assures efficient matching between the receiving coil 102 and an AC to DC circuit 114. The output of the resonance control circuit 110 is a matched AC signal 112. The AC to DC circuit 114 converts the matched AC signal 112 to a DC level 116, which can be either a DC current or a DC voltage. The DC level 116 is unregulated, so its magnitude may drift slowly over time, based on the strength of the charging field that is coupled to the receiving coil 102. The DC level 116 is provided to a charge control circuit 118, which includes a regulator circuit 120 and a controller 122. The regulator circuit 120 can be controlled to output a regulated DC level for charging a rechargeable battery 126. The controller 122 controls the regulator circuit 120 to output a desired DC level. For example, the regulator circuit 120 can regulate current through the battery 126 at a constant level, assuming sufficient electrical energy is received by the receiving coil 102.

In some embodiments the receiving coil 102, resonance control circuit 110, AC to DC circuit 114, and the charge control circuit can be disposed in a portable device that is powered by a detachable battery pack in which the battery 126 is located. A detachable battery pack can be connected to a portable device using a connector 124 (e.g. contacts). In some embodiments the device in which the receiving coil 102, resonance control circuit 110, AC to DC circuit 114, the charge control circuit, and the battery are located is a detachable battery pack.

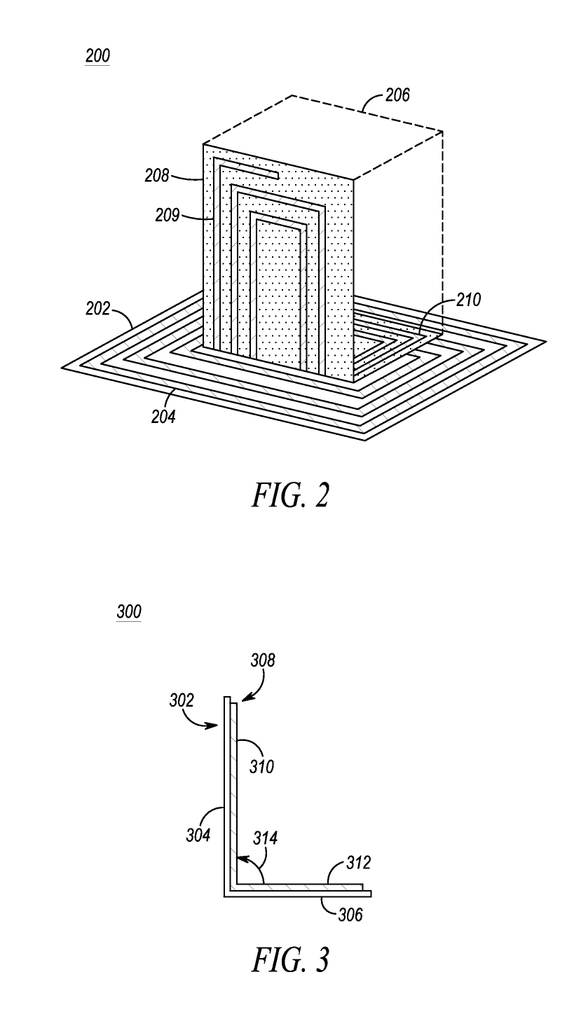

FIG. 2 is an isometric view 200 of a multi-plane receiving coil 208 for use in a device 206 to wirelessly recharge a battery, in accordance with some embodiments. The actual device 206 has been abstracted to a dashed line border in order to reveal the multi-plane receiving coil 208. The device 206 is placed on a charging surface in which a charging coil (i.e. transmitting) 202 is located. The charging coil 202 includes a plurality of windings 204. As used here the term “winding” refers to either a section of conductor which makes a complete loop around a center point, or the collection of such sections of conductor (e.g. a “primary” winding). Those of skill in the art, given the context in which the term is used, will understand whether the term refers to a single loop of conductor or a collection of successively wound loops in the aggregate. The charging coil includes a conductor winding such as winding 204, which can be a planar spiral winding comprised of a succession of winding loops that form a spiral. Thus, the charging coil can be formed on one layer of a circuit board in some embodiments.

The receiving coil 208 includes a first planar section 209, here oriented vertically, and a second planar section 210, here oriented horizontally, coplanar with the charging coil 202, forming an “L” shape. The receiving coil 208 includes a plurality of windings (successive loops around a center point) which have a portion of each winding/loop on the first planar section 209 and a portion of the winding/loop on the second planar section 210. Thus, individual winding loops traverse portions of both the first and second planar sections 209, 210 of the receiving coil 208.

The multi-plane receiving coil 208 is disposed in the device 206, and can be, for example, formed using a flexible circuit board that is bent to form the two different planes. In some embodiments the receiving coil 208 can be formed by plating conductor material on the interior surfaces of a polymeric housing of the device 206. The two different planes can thus be oriented at 90 degrees with respect to each other. For example, the first planar section 209 can be located along an inside back surface of the device 206, while the second planar section 210 can be located along the inside of a bottom surface of the device 206. By orienting the receiving coil in multiple planes it can be more effective at receiving energy from the charging coil 202 when the device 206 is placed in the wireless charger in different orientations, and at different locations on top of the charging coil. Thus, there is less variation in energy transfer based on the location of the device 206 on charging coil 202, which can allow additional devices to be placed on the charging coil 202.

FIG. 3 is a side view of an “L” shaped (when viewed from the side) receiving coil structure 300 for receiving power wirelessly from a charging coil of a wireless charger, in accordance with some embodiments. The L-shaped receiving coil structure 300 is shown from a side view to illustrate the “L” shape. A receiving coil 302 includes a first planar section 304, which is oriented vertically, and a second planar section 306, which is oriented horizontally, at a ninety degree angle 314 with respect to vertical. The receiving coil 302 can be formed similarly to receiving coil 208 of FIG. 2. However, in addition to the receiving coil 302, a ferromagnetic material 308 is layered with each planar section of the receiving coil 302. Thus, the ferromagnetic material includes a first section 310 that is layered with the first planar section 304 of the receiving coil 302, and a second section 312 that is layered with the second planar section of the receiving coil 302. By “layered” it is meant that a section of ferromagnetic material that is approximately the same shape and size as its respective planar section 304, 306 is in intimate proximity (i.e. within about 2 millimeters) with its respective planar section 304, 306 of the receiving coil 302. The ferromagnetic material 308 can be separated from the conductor material of the windings of the receiving coil 302 by a thin dielectric layer of material, such as the cover layer of a flexible circuit board in which the winding conductor is disposed. The ferromagnetic material 308 can be formed out of any of several well-known ferromagnetic materials, including stamped iron layers or ferrite and can have a thickness (normal to the planes of the planar sections) of up to 2 millimeters. The first section 310 and the second section 312 can be contiguous, and formed as a unitary piece in correspondence with the shape of the receiving coil 302.

When used with a wireless charger having a charging surface with a transmitting charging coil underneath, the ferromagnetic material 308 greatly enhances the ability of the receiving coil structure 300 to receive energy from the charging field in a way that greatly diminishes the dependence on location with respect to the charging coil, as well as orientation. If a device with only a single plane receiving coil is placed on a horizontally oriented charging coil, the receiving coil must also be horizontally oriented, and if the device is located at the periphery of the charging coil, the coupling efficiency is substantially diminished. By using a multi-plane receiving coil, the device in which the receiving coil is located can not only be oriented in multiple orientations, but the location with respect to the charging coil has much less effect on the coupling efficiency between the charging coil and the receiving coil.

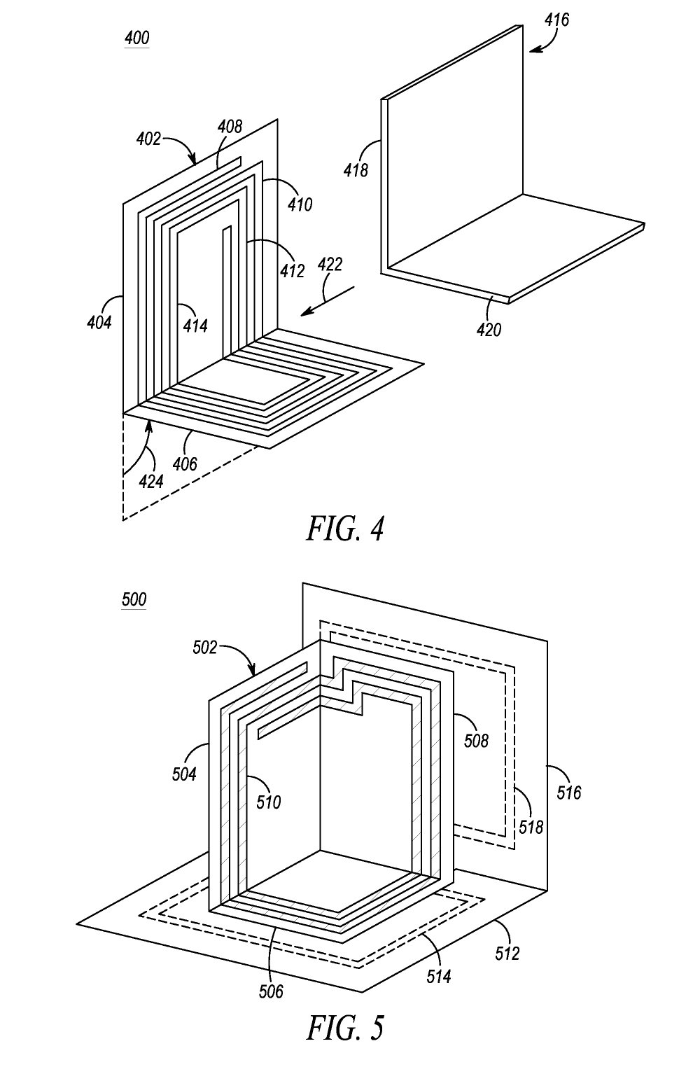

FIG. 4 is an exploded isometric view of an “L” shaped receiving coil structure 400 for receiving power wirelessly from a charging coil of a wireless charger, in accordance with some embodiments. The receiving coil structure 400 can be similar to the receiving coil structure 300 of FIG. 3. A receiving coil 402 in this example is formed in a flexible circuit board as a spiral-wound planar coil. The flexible circuit board can be bent along a midline to form a first planar section 404 and a second planar section 406. The midline can be located anywhere along the flexible circuit board, depending on the particular application. The flexible circuit board can be bent as indicated by arrow 424 so that the first and second planar sections 404, 406 are contiguous and oriented at an angle with respect to each other. The receiving coil 402 includes a plurality of windings 408, 410, 412, 414, which are formed by conductor traces which loop around a center region to form a spiral. Each of the windings 408, 410, 412, 414 have a portion of the winding on the first planar section 404 and a portion of the winding on the second planar section 406.

A ferromagnetic material layer 416 is placed in intimate proximity with the receiving coil, as indicated by arrow 422, to increase the coupling efficiency between the receiving coil 402 and the charging coil. The ferromagnetic material has a first section 418 that is layered with the first planar section 404 of the receiving coil 402, and a second section 420 that is layered with the second planar portion 406 of the receiving coil 402. While the first and second sections 418, 420 of the ferromagnetic material can be separate, they must be magnetically coupled so as to allow magnetic flux to freely traverse between. Forming the ferromagnetic material 416 as a unitary L-shaped member eliminates the issue of magnetically coupling individual sections, however. In some embodiments, where the receiving coil 402 is formed by metallization on the inside surfaces of a polymeric device housing, a thin dielectric insulator layer may be placed between the receiving coil 402 and the ferromagnetic material 416. In some embodiments the ferromagnetic material can be formed into the polymeric device housing using molding techniques to conform to the shape of the receiving coil. Likewise, in some embodiments, the conductor material forming the receiving coil can be insert molded into the housing material as well, or instead of the ferromagnetic material.

FIG. 5 is an isometric view of a multi-plane planar receiving coil structure 500 having more than two planes, in accordance with some embodiments. In some embodiments the multi-plane receiving coil structure can have sections on more than two planes. Receiving coil 502 includes, for example, a first planar section 504, a second planar section 506, and a third planar section 508, where the winding 510 has portions on all three planar sections 504, 506, 508. The winding 510 (including all winding loops) can be formed on the interior of three different surfaces of a substantially rectangular cuboid-shaped device. Having three planes can be of use to further alleviate orientation requirements of the device in which the receiving coil structure 500 is disposed. Furthermore, if the wireless charger includes charging coils on more than one plane, such as a horizontal charging surface 512 having a horizontally-oriented charging coil 514 and a vertically-oriented charging surface 516 having a vertically-oriented charging coil 518, the receiving coil structure 500 will ensure coupling via at least two of the planar sections 504, 506, 508. Ferromagnetic material can be used to further augment coupling efficiency between the receiving coil 502 and the charging coils 514, 518.

FIG. 9 is an isometric view of a multi-plane receiving coil structure 900 having a “U” shape (when viewed from the side), in accordance with some embodiments. Similar to the receiving coil structure 500 of FIG. 5, the multi-plane receiving coil structure 900 is a receiving coil 900 having more than two planar sections, including a first planar section 904, a second planar section 906, and a third planar section 908, where the windings of the receiving coil 902 have portions on all three planar sections 904, 906, 908. That is each winding loop traverses through each planar section 904, 906, 908. The receiving coil 902 can be formed in a flexible circuit board that is then bent or folded at two lines, where each fold can be at substantially 90 degrees. Accordingly, the receiving coil 902 can be disposed in a rectangular cuboid-shaped device housing such that, for example, the first planar section 904 can be against the interior surface of one side of the housing, the second planar section 906 can be against the interior surface of a bottom of the housing, and the third planar section 908 can be against the interior surface of a second side of the housing that opposes the first side against which the first planar section 904 is against. Between the first and third planar sections 904, 908, various device circuitry and components can be placed. Ferromagnetic material can be layered with the first, second, and third planar sections 904, 906, 908 substantially as taught in FIGS. 3-4. By adding a third planar section the chance that a device incorporating the multi-plane receiving coil will be placed on a charging surface with a planar section 904, 906, 908 in close proximity to the charging surface is increased. Furthermore, if the device is set on the charging surface on one of the open sides (i.e. where there is no planar section of the receiving coil) all three planar sections 904, 906, 908 will be oriented vertically with respect to the charging surface, and will have increased coupling compared to embodiments using two planar sections.

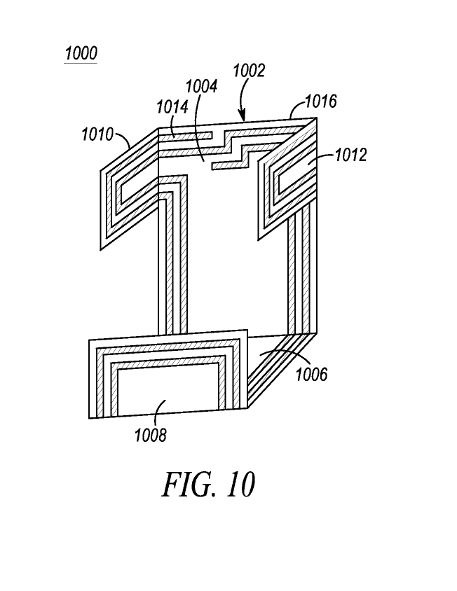

FIG. 10 is an isometric view of a multi-plane receiving coil 1000 having a “J” shape (when viewed from the side) and including flaps, in accordance with some embodiments. The J-shaped receiving coil can be embodied in a flexible circuit board 1002, and includes a first planar section 1004, a second planar section 1006, and a third planar section 1008, which are arranged in an approximate “J” shape (a flattened “J”). The first and third planar sections 1004, 1008 can be substantially parallel, but the third planar section 1008 is substantially shorter than the first planar section 1004. The first and third planar sections 1004, 1008 can be bent at substantially 90 degrees relative to the plane of the second planar section 1006. The flexible circuit board 1002 can further include flaps 1010, 1012, which are also contiguous regions of the flexible circuit board which can be bent relative to other sections of the flexible circuit board. A receiving coil can be formed of a conductor 1014 which can traverse the first, second, and third planar sections 1004, 1006, 1008, as well as the flaps 1010, 1012 on each winding loop. The result is a multi-plane receiving coil that can have portions on most or all sides of the inside of a portable device. For example, and additional flap could be formed contiguous with the top edge 1016 of the first planar section, which would result in 6 different planes being traversed by the receiving coil conductor 1014. It will be appreciated by those skilled in the art that shapes having a side profile similar to that of the letters J, L, and U (as in the basic Latin alphabet defined by the International Organization for Standardization) can serve as a basis for a multi-plane receiving coil, as can the three sided shape shown in FIG. 5, and other multi-plane shapes. The different planar sections, including flaps, can be formed to be of similar shapes and sizes, or of dissimilar shapes and/or sizes, so long as they are not mono-planar and allow a device to be oriented in multiple orientations with respect to a wireless charger without substantial differences in coupling efficiency.

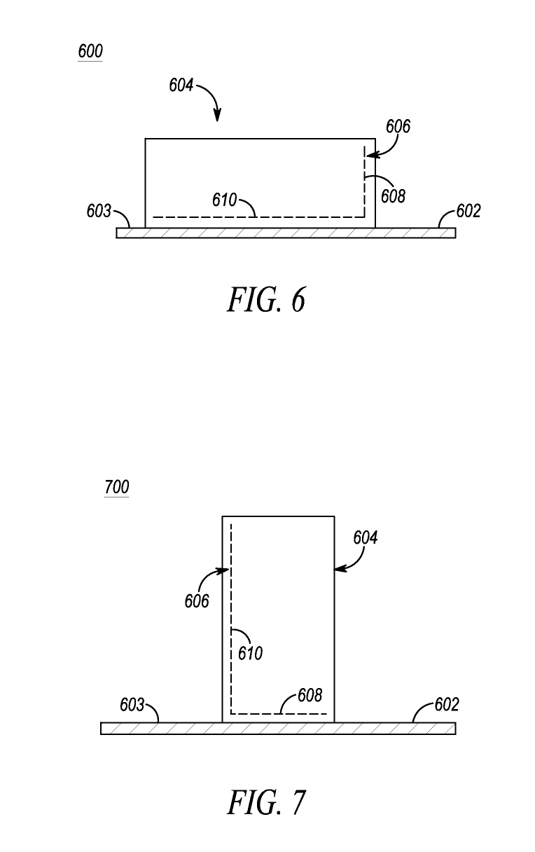

FIG. 6 is a side view 600 of a device 604 using a multi-plane receiving coil structure 606 with the device 604 laying on its side on top of a charging surface 602 of a wireless charger, in accordance with some embodiments. The charging surface 602 includes a charging coil 603 disposed in the plane of the charging surface (i.e. normal to the plane of the page). The device 604 can be any device having a rechargeable battery, either attached or incorporated into the device 604. Examples of devices can include mobile communication devices, portable two-way radio device, battery packs for use with portable devices, and so on. The receiving coil structure 606 is seen in dashed line from the side and includes a multi-plane receiving coil having a first planar section 608 and a second planar section 610. As shown, the second planar section 610 is parallel to the plane of the charging surface 602, allowing coupling between the second planar section 610 via field lines normal to the plane of the charging surface. However, when the receiving coil structure 606 includes ferromagnetic material layered with both the first and second planar sections 608, 610, it will further direct the field up to couple into the first planar section 608 as well, further increasing the coupling efficiency.

FIG. 7 is a side view 700 of a device 604 using a multi-plane receiving coil structure 606 with the device 604 standing upright on top of a charging surface 602 of a wireless charger, in accordance with some embodiments. This view is similar to that of FIG. 6, using the same device 604, but set on its bottom on the charging surface 602. In this orientation, the first planar section 608 of the receiving coil structure 606 is parallel to the charging surface 602, coupling it to the charging field produced by the charging coil 603. A layer of ferromagnetic material can be placed in intimate proximity with the first and second planar sections 608, 610 to increase the coupling efficiency in the vertically oriented second planar section 610 by directing field flux into the second planar section 610 from the charging coil 603.

In testing it has been found that when a single plane receiving coil is used, and the device in which the single plane receiving coil is disposed is oriented such that the receiving coil plane is perpendicular to that of the charging surface/charging coil, the coupling efficiency drops to near zero. As the device is tilted from the vertical to the horizontal, the coupling efficiency increase to being close to 100% when the receiving coil and the charging coil planes are parallel and the receiving coil and the charging coil are in close proximity in the center of the charging coil. However, even when horizontally oriented to be in parallel planes, when the device is moved to an edge of the charging coil, the coupling efficiency decreases substantially. When a multi-plane charging coil structure is used, however, the coupling efficiency can be maintained to over 80% at the edges of the charging coil. Furthermore, using only a single plane coil with a ferromagnetic material does not substantially improve coupling when the single plane coil structure is oriented to be anti-parallel to the plane of the charging coil. Hence, a multi-plane coil solves the problem of miss-oriented devices with respect to a charging coil, and when only single charging coil is present, the presence of the ferromagnetic material allows increased coupling in the planar section that is not parallel with the charging coil.

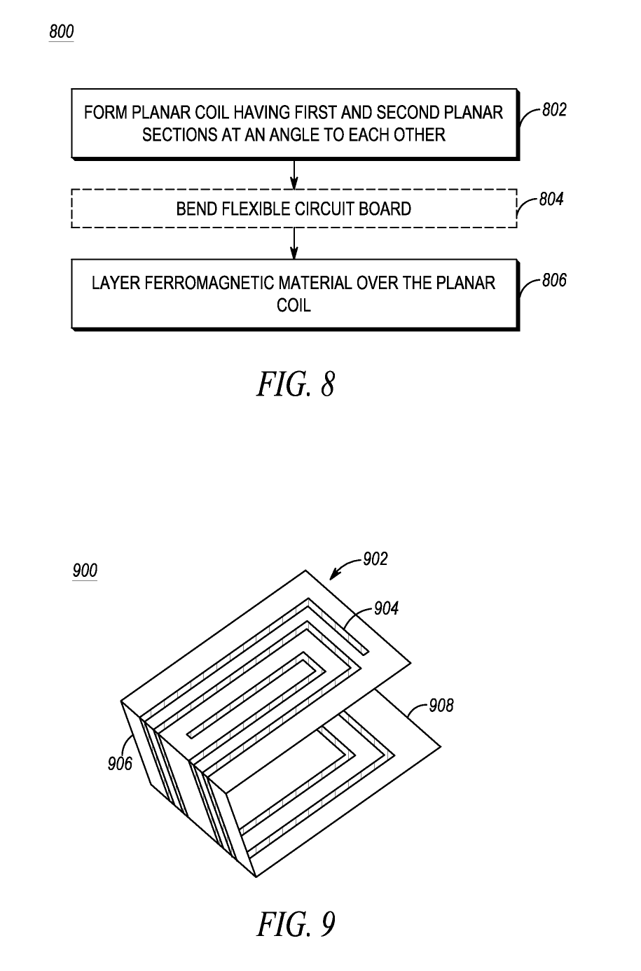

FIG. 8 is a flow chart diagram 800 of a method of forming a multi-plane receiving coil structure, in accordance with some embodiments. The first step 802 involves forming a planar coil having at least first and second planar sections. The sections can be formed at an angle with respect to each other. The planar coil is a receiving coil and has a plurality of winding loops which each traverse each planar section. In some embodiments the planar coil can be formed by metallization of the inside or interior surfaces of a device housing. In some embodiments the planar coil can be formed in a flexible circuit board. Equivalent means for forming a multi-plane receiving coil can occur to the skilled in the art. In step 804 embodiments using a flexible circuit board containing a planar coil include bending or folding the flexible circuit board so as to form the two planar sections that are then contiguous and non-parallel. In some embodiments the two planes can be oriented at ninety degrees with respect to each other (e.g. an “L,” “J,” or flat bottomed “U” shape). In step 806 a ferromagnetic material can be layered with the planar coil to increase coupling efficiency.

The various embodiments provide the benefit of increasing the coupling efficiency between a charging coil of a wireless charger and a receiving coil in a device to be charged by the wireless charger. By using a multi-plane receiving coil the device can be oriented in multiple orientations with respect to the charging coil without substantially reducing the coupling efficiency. Furthermore, the use of a receiving coil structure in accordance with the various embodiments eliminates the loss of coupling efficiency when positioned near the periphery of the charging coil as occurs with single plane receiving coils.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A charging circuit for receiving a wireless charging signal, comprising:
a receiving coil having a plurality of windings and having a first planar section and a second planar section that is contiguous with the first planar section and oriented at an angle with respect to the first planar section, each winding of the plurality of windings having a first portion of the winding in the first planar section and a second portion of the winding in the second planar section; and
ferromagnetic material having a first section that is layered with the first planar section of the receiving coil and a second section that is layered with the second planar section of the receiving coil.

2. The charging circuit of claim 1, wherein the ferromagnetic material is ferrite.

3. The charging circuit of claim 1, wherein the receiving coil is a planar coil that is spiral wound in a flexible circuit board that is bent to form the first planar section and the second planar section.

4. The charging circuit of claim 1, further comprising:
an AC to DC conversion circuit; and
a resonance control circuit coupled to the receiving coil to match a resonance of the receiving coil to the AC to DC circuit;
wherein the AC to DC circuit converts an AC signal received at the receiving coil to a DC current or a DC voltage.

5. The charging circuit of claim 1, further comprising:
The receiving coil having at least one additional planar section, where each winding of the plurality of windings having at least one additional portion in the at least one additional planar section.

6. The charging circuit of claim 5, wherein the first and second planar sections and the at least one additional planar section from a U or a J shape.

7. The charging circuit of claim 1, wherein the first and second planar sections of the receiving coil are formed in an “L” shape and are oriented at 90 degrees.

8. The charging circuit of claim 1, wherein the receiving coil and ferromagnetic material are disposed in a battery pack.

9. The charging circuit of claim 1, wherein the receiving coil and ferromagnetic material are disposed in a portable device that is powered by a rechargeable battery.

10. A method of forming a receiving coil for wireless charging, comprising:
forming a planar coil with a plurality of successive spiral windings and having a first planar section and a second planar section that are oriented at an angle with respect to each other, wherein the successive spiral windings each have a portion in the first planar section and the second planar section; and
layering a first section of ferromagnetic material with the first section of the first planar section of the planar coil and a second section of the ferromagnetic material with the second planar section of the planar coil.

11. The method of claim 10, wherein forming the planar coil comprises forming the planar coil in a flexible circuit board and bending the flexible circuit board to form the first and second planar sections.

12. The method of claim 10, wherein layering the first and second sections of ferromagnetic material comprises bending the planar coil around a bend of an “L” shaped ferromagnetic member.

13. The method of claim 10, wherein layering the first and second sections of ferromagnetic material comprises layering first and second sections of ferrite.

14. The method of claim 10, wherein the planar coil is formed on an inside surface of a polymeric housing, wherein the first planar section is formed on a first portion of the inside surface and the second planar section is formed on a second portion of the inside surface that is contiguous with the first portion of the inside surface.

15. The method of claim 10, wherein forming the first and second planar sections comprises forming the first and second planar sections at a 90 degree angle to each other.

16. A device, comprising:
a receiving coil structure including a plurality of windings and having a first planar section and a second planar section, wherein the first and second planar sections are oriented at an angle with respect to each other;
an AC to DC conversion circuit coupled to the charging coil structure that receives an AC signal from the receiving coil structure and converts the AC signal into a DC signal; and
a charge controller that applies the DC signal to a rechargeable battery.

17. The device of claim 16, wherein the plurality of windings are formed by a spiral wound planar coil where each of the plurality of windings has a first portion of the winding in the first planar section and a second portion of the winding in the second planar section.

18. The device of claim 17, wherein the spiral wound planar coil is formed in a flexible circuit board, and wherein the flexible circuit board is bent to form the first and second planar sections.

19. The device of claim 16, further comprising a ferromagnetic material having a first section that is layered with the first planar section of the receiving coil structure and a second section that is layered with the second planar section of the receiving coil structure.

20. The device of claim 15, wherein the first planar section of the plurality of windings is formed on a first inside surface of a housing of the device, and the second planar section is formed on a second inside surface of the housing, wherein the first and second inside surfaces are contiguous.

21. The device of claim 16, further comprising contacts for electrically connecting to the rechargeable battery.
